(19) United States
(12) Patent Application Publication
(10) Pub. No.: US 2007/0063916 A1
(43) Pub. Date: Mar. 22, 2007

(54) Versatile antenna for wireless communications

(76) Inventor: Bernard Louis Malone III, Little Rock, AR (US)

Correspondence Address: CARLSON, GASKEY & OLDS, P.C., 400 W MAPLE RD, SUITE 350, BIRMINGHAM, MI, 48009, US

(21) Appl. No.: 11/231,484

(22) Filed: Sep. 21, 2005

(51) Int. Cl. H01Q 1/12

(52) U.S. Cl. 343/877; 343/707

(57) ABSTRACT

An antenna assembly (20) includes an antenna (22) supported near one end of an elongated probe (24). The antenna (22) in one example includes a substantially rigid outer shell (40) to allow the antenna to withstand a variety of environmental conditions. The elongated probe facilitates moving the antenna (22) into a variety of locations that are relatively inaccessible such as within piles of debris or other locations where traditional wireless communication systems are not able to detect communication signals.

### FIELD OF THE INVENTION

This invention generally relates to communications. More particularly, this invention relates to wireless systems.

### DESCRIPTION OF THE RELATED ART

Wireless communication systems are well known. Geographic regions are divided into cells or sectors that are served by base station transceivers. Mobile stations, such as cellular phones, communicate with a base station when the mobile station is within the corresponding cell, for example. As the mobile station moves between cells, the various base stations communicate signals to and from the mobile stations.

Under most circumstances, known wireless communication networks serve their intended purposes. There are occasions when a wireless communication network would be useful but the normal communication techniques render the network less than optimal for addressing such situations. For example, a disaster or emergency situation may be handled using wireless communications to minimize the damage or effects of such a situation.

Consider the attack on the World Trade Center in New York City, for example. There were significant efforts to search for and rescue individuals trapped in the rubble who may have had a cell phone or other wireless communication device. The limitations on traditional wireless communication networks prevent or degrade any use of wireless communication devices for such situations. For example, the debris associated with the collapse of the World Trade Center made it impossible for adequate signal transmission between base station transceivers and mobile stations within the rubble. Additionally, much of the network infrastructure in the vicinity of the World Trade Center was damaged and, therefore, not effective. Further, the additional load on the system from the large number of individuals attempting to contact others using wireless communications taxed system resources, which made them less available for targeted search and rescue efforts.

There is a need for enhancing wireless communication systems to improve communications with or search and rescue of individuals using wireless communication devices in emergency or disaster situations.

For example, it would be useful to be able to establish communication with a mobile station located where signals from that mobile station cannot be detected using existing wireless communication hardware. It would be useful to be able to at least detect signals from a mobile station within a pile of rubble, for example. The mass associated with such rubble typically interferes with the transmission of wireless communication signals from a mobile station such that it cannot be located using traditional arrangements.

There is a need for a device that is able to at least detect wireless signals from a mobile station, for example, under a wider variety of circumstances.

### SUMMARY OF THE INVENTION

This invention addresses the need for a device that improves the ability to at least detect signals from a mobile station. An exemplary disclosed antenna assembly has the ability to probe into relatively inaccessible places for detecting wireless communication signals where they otherwise would not be detectable.

A disclosed example antenna assembly includes an antenna for at least detecting a selected type of radiation, such as a wireless communication signal from a mobile station. A substantially rigid shell covers over at least a portion of an exterior of the antenna. An elongated probe supports the antenna near one end of the probe. The probe allows for selectively moving the antenna into an area and subsequently removing the antenna from the area. The antenna is therefore able to detect signals at a variety of locations that were otherwise inaccessible.

One example assembly includes an indicator associated with the antenna for indicating whether the antenna detects the selected type of radiation.

One example includes a communication device, which comprises a portable base station transceiver, coupled with the antenna. The communication device allows for communication with the mobile station or communicating information to a wireless network regarding signals detected by the antenna.

Another example includes a radio frequency communication signal repeater as the communication device. Another example includes a mobile station associated with the antenna such that the mobile station acts as a communication device for transferring signals between the antenna and a wireless communication network, for example.

The various features and advantages of this invention will become apparent to those skilled in the art from the following detailed description. The drawings that accompany the detailed description can be briefly described as follows.

### BRIEF DESCRIPTION OF THE DRAWINGS

FIG. 1 schematically shows an antenna assembly designed according to an embodiment of this invention.

FIG. 2 schematically shows selected portions of the embodiment of FIG. 1.

FIG. 3 is an enlarged view of a portion of the embodiment of FIG. 2.

FIG. 4 is a cross-sectional illustration taken along the lines 4-4 in FIG. 2.

FIG. 5 is a cross-sectional illustration taken along the lines 5-5 in FIG. 3.

FIG. 6 schematically illustrates an example display available with one embodiment of this invention.

### DETAILED DESCRIPTION

A disclosed example antenna assembly provides the ability to at least detect a signal from a mobile station. One use for such an antenna is to search for and locate individuals by detecting or locating mobile stations in the possession of or at least near such individuals. The disclosed example includes a robust, versatile antenna that is capable of entering relatively inaccessible areas for detecting radiation such as wireless communication signals within those areas where such signals would otherwise be undetectable.

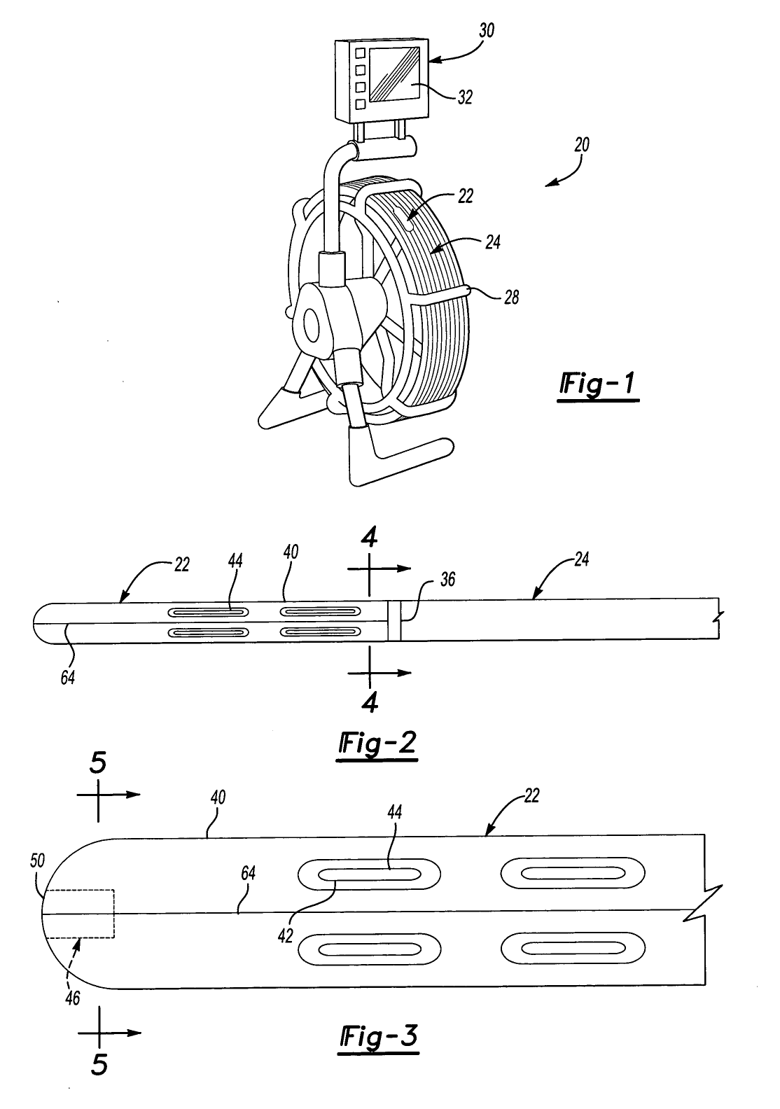

FIG. 1 schematically shows one example antenna assembly 20 that includes an antenna 22. The example antenna 22 is at least a one-way antenna that is capable of detecting a selected type of radiation. One example includes a bi-directional antenna 22 that is useful for detecting or receiving signals from an external source and for transmitting signals from the antenna 22.

The illustrated example assembly 20 includes an elongated probe 24 supporting the antenna 22 near one end of the probe. The probe 24 is capable of propelling the antenna 22 in a forward direction so that the antenna 22 can enter into relatively inaccessible places. For example, the antenna 22 is capable of traveling through crevices and small spaces within piles of debris into a variety of locations. The elongated probe 24 allows for moving the antenna 22 into a variety of locations and retracting or retrieving the antenna from those locations.

The elongated probe 24 in one example is constructed of similar materials and operates similar to industrial pipeline or sewer inspection probes, a variety of which are known. The illustrated example includes a drum assembly 28 and a supporting frame for manipulating the probe 24 in a desired manner.

The illustrated example includes a communication device 30 associated with the antenna 22. In this example, the elongated probe 24 supports at least one conductor extending between the antenna 22 and the communication device 30. The conductor facilitates transmitting signals between the antenna 22 and the communication device 30. In the illustrated example, the communication device 30 includes at least one display or indicator 32 to provide information to an individual regarding signals detected by the antenna 22.

In one example, the communication device 30 comprises a portable base station transceiver that operates similar to base station transceivers in known wireless communication networks. In another example, the communication device 30 comprises a signal repeater that is operative to repeat signals detected by the antenna 22 so that those signals can be processed by a remotely located device such as a wireless communication network base station transceiver. A signal repeater in one example repeats signals from a base station transceiver so that they are transmitted from the antenna 22 toward a mobile station, for example.

In one example, the communication device 30 includes the indicator 32 for providing an indication whether the antenna 22 is detecting any selected type of radiation such as a radio frequency wireless communication signal. In one example, the indicator 32 includes one visible indicator for showing when the antenna 22 detects radiation or a signal and another indicator for showing when the antenna 22 is not detecting any selected type of radiation or signal. Such an example may be useful as an initial searching or probing device for locating sources of selected radiation or wireless communication signals, for example. Upon locating a source of such a signal, another communication device may be associated with the antenna 22 or another similar antenna for attempting to utilize more information regarding the detected signal or to attempt communications with the mobile station providing the signal.

In one example, the communication device 30 is configured as a mobile station so that it can communicate with a wireless communication network in a generally known manner. At the same time, the mobile station communication device 30 can utilize information gathered by the antenna 22 or use the antenna 22 as a transmitter for transmitting signals into an area near the antenna 22.

The communication device 30 in one example has programming sufficient to determine at least one characteristic of a detected signal or radiation. For example, the communication device 30 in one embodiment provides an indication of the type of signal detected by the antenna 22. Such information may facilitate subsequent rescue attempts where the communication signals is of a character or includes content that indicates that search and rescue efforts are appropriate.

FIG. 2 shows somewhat more detail of one example embodiment where the antenna 22 is coupled to an end of the elongated probe 24 using a coupler 36. In this example, the antenna 22 has a length designed to facilitate appropriate signal detection for a selected type of radiation (e.g., radio frequency wireless communication signals from a mobile station). Given this description, those skilled in the art will be able to select antenna dimensions to meet their particular needs. Example antenna configurations have lengths in a range from about a few centimeters to about a few meters for some applications. The elongated probe 24 in one example has a length of approximately 30 meters.

FIG. 2 schematically shows an example coupler for supporting the antenna 22 at one end of the elongated probe 24.

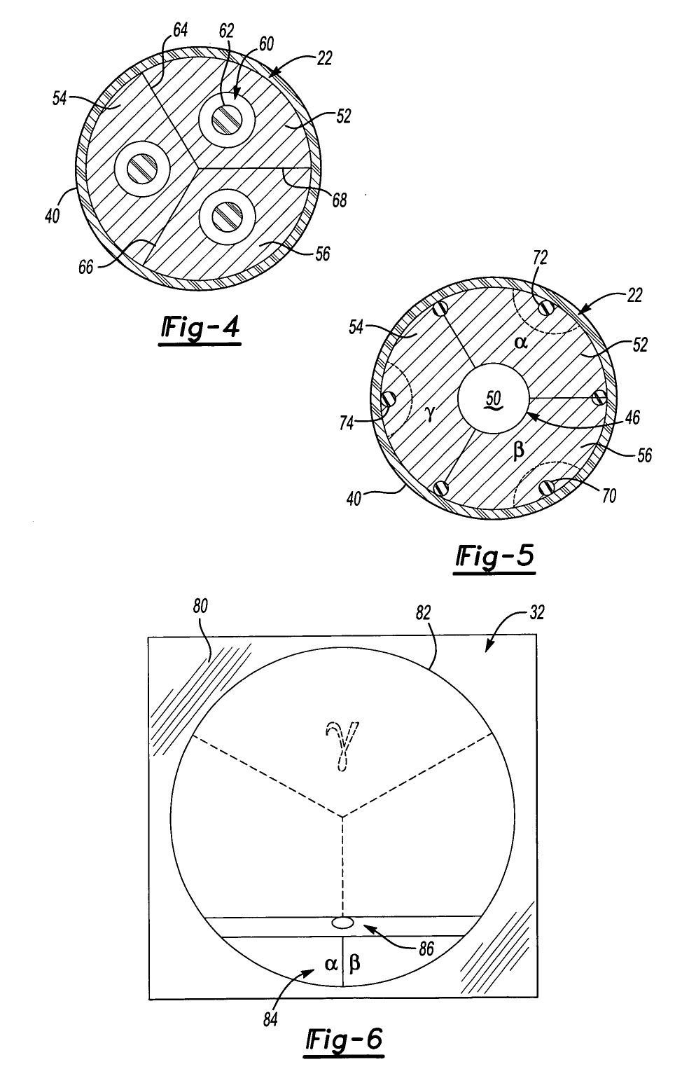

Because the antenna 22 is intended to be moved into a variety of locations, some examples are designed to withstand a variety of environmental conditions. For example, the antenna 22 may be moved in a manner that it penetrates through a pile of debris including sharp edges and hard materials. The antenna 22 in this example has a substantially rigid outer shell 40 along at least a portion of the exterior of the antenna 22. In some examples, the shell 40 comprises the same material as the antenna that is treated to provide a desired resiliency on the exterior surface. In another example, the outer shell 40 comprises a sheath fitted over at least a portion of the antenna 22. In one example, the sheath comprises a plastic material. FIGS. 4 and 5, for example, show an outer shell 40 comprising a plastic sheath.

When the outer shell 40 comprises a covering over the antenna 22, openings 42 within the sheath or covering allow for some of the antenna material to be exposed as shown at 44 in FIG. 3, for example. Such openings allow for radiation to be transmitted from or to be detected by the antenna 22 without interference caused by the protective covering or outer shell 40.

This description refers to a substantially rigid outer shell, which is intended to mean that the shell is generally hard but may have some flexibility to accommodate impacts or collisions with hard materials that will not permanently deform the antenna 22. A variety of plastic materials are known that provide a substantially rigid surface that has some flexibility yet is generally hard. Those skilled in the art who have the benefit of this description will be able to select appropriate materials to realize a robust antenna design to meet the needs of their particular situation.

The example of FIG. 3 includes a recess 46 near one end of the antenna 22 for receiving a camera 50. This embodiment has the added capability of providing some visual feedback regarding the environment in which the antenna 22 is placed. A variety of known camera devices can be utilized for such purposes. One example includes an infrared camera to provide so-called night vision capabilities. When a camera 50 is included with the antenna 22, the elongated probe 24 supports appropriate conductors for communicating power to the camera as needed and for receiving signals regarding what is within the field of vision of the camera 50.

Referring to FIG. 4, an example antenna 22 is a directional antenna that is capable of discrete sector or zone communication. In this example, three different sectors are schematically shown at 52, 54 and 56. Radiation from the antenna 22 may be directed along a beam path associated with any one of these sectors on an as-needed basis in one example. Similarly, radiation received by the antenna 22 from within a corresponding one of the sectors may be discerned as such. Such directional information allows for more accurate communications and more accurate location information from the antenna 22.

The example of FIG. 4 is capable of operating as an omni-directional antenna when all three illustrated sectors operate together. Another example omni-directional antenna does not have discrete sectors.

FIG. 4 also schematically shows a connector 60 for connecting conductors or feedlines 62 with each sector of the antenna 22. In one example, the conductors 62 are supported along the length of the elongated probe 24 for appropriately coupling the communication device 30 with the antenna 22.

The example of FIG. 4 also includes sector separators 64, 66 and 68 that isolate radiation associated with one sector from the others. An appropriate insulating material for the sector separators may be selected to meet the needs of a particular situation.

The example antenna 22 is manipulative relative to the elongated probe 24. One example includes a coupling 36 that allows the antenna 22 to be pivoted relative to the probe 24 in a variety of directions. FIG. 5 schematically shows positioning members 70, 72 and 74 associated with each of the example sectors or portions of the antenna 22. In one example, each positioning member comprises a retracting cable that is supported along the length of the elongated probe 24 so that an actuator (not illustrated) of the antenna assembly 20 can manipulate any one of the positioning members to cause the antenna 22 to move relative to the elongated probe 24. Such an arrangement allows for steering the antenna into a desired location, for example.

Examples that include a camera 50 provide the capability for an individual to receive visual feedback regarding the area in which the antenna 22 is located. FIG. 6 schematically shows one example display 80 as part of one example indicator 32. The display 80 in this example includes an image 82 corresponding to a field of vision of the camera 50. In this example, the image 80 has markings corresponding to the relative positions of the portions of the antenna 22 for each of the sectors mentioned above. The illustrated example also includes a sector indicator portion 84 that indicates which sector is where in the image 82. Referring to the sectors in FIG. 5, for example, the indicator portion 84 shows the sectors 72 and 70 pointing generally downward (according to the drawing). The image 82 also includes a level indicator 86 that provides information regarding the orientation of the antenna 22. For example, the image 82 in the illustrated example shows that the sector 54 (see, for example FIG. 5) is currently the top sector and that it is in a vertically upward orientation relative to gravity. Visual information regarding the area surrounding the antenna 22 may facilitate search and rescue efforts when a communication signal is detected by the antenna 22 in a particular location.

The disclosed example provides an antenna assembly that is capable of moving into a variety of locations and withstanding a variety of environmental conditions to try to detect radiation such as radio frequency communication signals used by mobile stations. Such an assembly enhances the ability to search for, communicate with, or rescue individuals in a variety of situations including disaster conditions or military operations, for example.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

1. An antenna assembly, comprising:
a substantially rigid shell over at least a portion of an exterior of an antenna that detects a selected type of radiation; and
an elongated probe supporting the antenna near one end of the probe for selectively moving the antenna into an area for at least detecting the selected type of radiation and subsequently removing the antenna from the area.

2. The assembly of claim 1, comprising an indicator coupled with the antenna for indicating whether the antenna detects the selected type of radiation.

3. The assembly of claim 2, wherein the indicator provides a first indication if the antenna detects the radiation and a second indication if the antenna does not detect the radiation.

4. The assembly of claim 2, wherein the radiation comprises at least one radio frequency signal.

5. The assembly of claim 1, comprising a communication device coupled with the antenna for at least determining one characteristic of a radio frequency signal detected by the antenna.

6. The assembly of claim 5, wherein the communication device comprises a portable base station transceiver.

7. The assembly of claim 5, wherein the communication device comprises a radio frequency communication signal repeater.

8. The assembly of claim 5, wherein the communication device comprises a mobile station that is adapted to communicate with a wireless communication network.

9. The assembly of claim 1, wherein the substantially rigid shell comprises a sheath having a plurality of openings exposing corresponding portions of the antenna.

10. The assembly of claim 1, wherein the substantially rigid shell comprises plastic.

11. The assembly of claim 1, wherein the elongated probe supports at least one conductive line coupled with the antenna.

12. The assembly of claim 11, wherein the antenna comprises a directional antenna that at least receives signals from a plurality of directions and comprising at least one conductive line associated with each of the plurality of directions.

13. The assembly of claim 12, comprising an insulating separator between at least two portions of the antenna and wherein each of the portions corresponds to one of the directions.

14. The assembly of claim 12, comprising an indicator that indicates which of the directions corresponds to radiation detected by the antenna.

15. The assembly of claim 1, comprising a camera associated with the antenna for providing a visible indication of the area where the antenna is located.

16. The assembly of claim 1, comprising at least one positioning member that is operative to move the antenna into a selected orientation.

17. The assembly of claim 16, wherein the positioning member comprises an elongated retractor extending along at least a portion of the length of the probe and including an actuator for moving the elongated retractor in a direction that results in a change in orientation of the antenna relative to the probe.

18. The assembly of claim 16, wherein the antenna comprises a multi-directional antenna that is arranged into a plurality of sectors and including at least one positioning member associated with each sector for moving the antenna along a direction corresponding to a position of the sector relative to the antenna.
